(19) United States
(12) Patent Application Publication
(10) Pub. No.: US 2018/0219924 A1
(43) Pub. Date: Aug. 2, 2018

(54) Method and System for Providing Interactive Control of Shared Content Over a Video Conference

(71) Applicant: Wipro Limited, Bangalore (IN)

(72) Inventor: Sudhakar Getamaneni NAGABUSHANAM, Bangalore (IN)

(73) Assignee: Wipro Limited

(21) Appl. No.: 15/459,265

(22) Filed: Mar. 15, 2017

(30) Foreign Application Priority Data
Jan. 31, 2017 (IN) 201741003640

(51) Int. Cl. H04L 29/06; H04L 29/08

(52) U.S. Cl. CPC H04L 65/403; H04L 67/42; H04L 67/14; H04L 67/10

(57) ABSTRACT

A method and system are described for providing interactive control of shared content over a video conference to a user. The method includes receiving a content control request from the user of a client device, the content control request being raised by the user on the shared content. The method includes segmenting the shared content into one or more content segments based on the content control request. The method includes modifying presentation of the one or more content segments based on the content control request. The method includes presenting, by the content server, the one or more content segments to the user on the client device.

### TECHNICAL FIELD

The present subject matter is related, in general to conference systems, and more particularly, but not exclusively to, a method and a system for providing interactive control of shared content over a video conference.

### BACKGROUND

A multi-party video conference may typically have presentation of shared content which is presented and controlled by one person and received by other participants or clients at any time. Different participants may have video or audio mode of participation. The presentation of the shared content may be rendered to a plurality of participants with view only access on the shared content. In a current scenario, only the presenter may have content controls, for example zoom in, zoom out or move, for the shared content being presented.

At present, video conferencing, systems do not have options to offer control and or respond to requests of changing a focus area of presentation of the shared content, based on a particular requirement of the client receiving the shared content. Therefore, the client receiving the shared content may not be able to properly view the an area of interest in the shared content, due to lack of control over shared content, resulting in less engagement of the participants. The participants may make back-to-back requests to the presenter to move up or move down, zoom in or zoom out, and the like. However, such a process is manual, tedious and results in wastage of time.

Further, limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there may be provided a method of providing interactive control of shared cement over a video conference to a user. The method may include receiving, by a content server, a content control request from the user of a client device, the content control request being raised by the user on the shared content. The method may further include segmenting, by the content server, the shared content into one or more content segments based on the content control request. The method may include modifying, by the content server, presentation of the one or more content segments based on the content control request. The method may further include presenting, by the content server, the one or more content segments to the user on the client device.

According to embodiments illustrated herein, there may be provided a content server for providing interactive control of shared content over a video conference to a user. The content server may include a processor and a memory communicatively coupled to the processor. The memory stores processor instructions, which, on execution, causes the processor to receive a content control request from a user of a client device, the content control request being raised by the user on the shared content. The processor may be configured to segment the shared content into one or more content segments in accordance with the content control request. The processor may be further configured to modify presentation of the one or more content segments based on the content control request. The processor may be configured to present the one or more content segments to the user on the client device.

According to embodiments illustrated herein, a non-transitory computer-readable storage medium having stored thereon, a set of computer-executable instructions for causing a computer comprising one or more processors to perform steps of providing interactive control of shared content over a video conference to a user. The one or more processors may be configured to receive a content control request from a user of a client device, the content control request being raised by the user on the shared content. The one or more processors may be configured to segment the shared content into one or more content segments in accordance with the content control request. The one or more processors may be configured to modify presentation of the one or more content segments based on the content control request. The one or more processors may further be configured to present the one or more content segments to the user on the client device.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, incorporated in constituting a part of this disclosure, illustrate exemplary embodiments and, together with the description, serve to explain the disclosed principles. In the figures, the left-most digit(s) of a reference number identifies the figure in a which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 is a block diagram that illustrates a system environment in which various embodiments of the method and the system may be implemented;

FIG. 2 is a block diagram that illustrates a content server configured to provide interactive control of shared content over a video conference to a user, in accordance with some embodiments of the present disclosure;

FIG. 3 is a flowchart illustrating a method of providing interactive control of shared content over a video conference to a user, in accordance with some embodiments of the present disclosure;

FIG. 4 is a flowchart illustrating a method of providing interactive control of shared content over a video conference to a user, in accordance with other embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example;” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

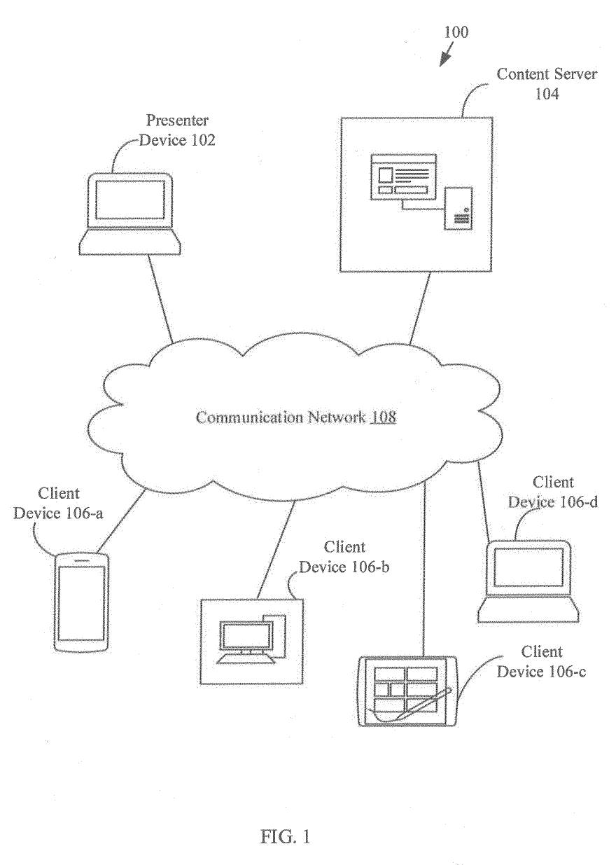

FIG. 1 is a block diagram that illustrates a system environment 100 in which various embodiments of the method and the system may be implemented. The system environment 100 may include a presenter device 102, a content server 104, client devices 106-a, 106-b, 106-c, 106-d, which may be collectively referred to as client devices 106, and a communication network 108. The content server 104 may be communicatively coupled to the presenter device 102 and the client device(s) 106 via the communication network 108. In an embodiment, the content server 104 may communicate with the presenter device 102 using one or more protocols. Examples of the protocols include, but are not limited to, open database connectivity (odbc) protocol and Java database connectivity (jdbc) protocol. In an embodiment, the client device(s) 106 may communicate with the content server 104, through the communication network 108.

In an embodiment, the presenter device 102 may be configured to transmit the shared content to the content server 104 via the communication network 108. Further, the content server 106 may be configured to store one or more shared content transmitted by the presenter device 102 to the content server 104. In an embodiment, the content server 104 may be configured to transmit to the client device 106, a set of operations associated with the shared content, based on a content control request received from the client device 106. In an embodiment, the shared content may be a shared content as shared in a video conference. The shared content may include, but is not limited to slides, decks, documents, and pictures. Throughout the specification, the shared content has also been referred to shared content and they have been interchangeably used for the purposes of explanation.

A person with ordinary skills in the art will understand that the scope of the disclosure is not limited to the content server 104 as a separate entity. In an embodiment, the functionalities of the content server 104 may be integrated into the presenter device 102 and vice versa. In an embodiment, the functionalities of the content server 104 may be integrated to the client device 106 and vice versa.

In an embodiment, the content server 104 may refer to a computing device or a software framework hosting an application or a software service. In an embodiment, the content server 104 may be implemented to execute procedures the examples of which are not limited to, programs, routines, or scripts stored in one or more memories for supporting a hosted application or the software service. In an embodiment, the hosted application or the software service may be configured to perform one or more predetermined operations. The content server 104 may be realized through various types of application servers such as, but are not limited to, a Java application server, a NET framework application server, a Base4 application server, a PHP framework application server, or any other application server framework.

In an embodiment, the content server 104 may be configured to perform segmentation of shared content and image enhancement of the shared content that is segmented. The content server 104 may be configured to receive, from the client device 106, a control request for the shared content. The content server 104 may be configured to perform one or more processing operations on the shared content. The content server 104 may be configured to identify one or more client devices 106. The content server 104 may be configured to identify one or more attributes of the client devices 104. In an embodiment, the content server 104 may be configured to store a list of the client devices 104 and the attributes of the client devices.

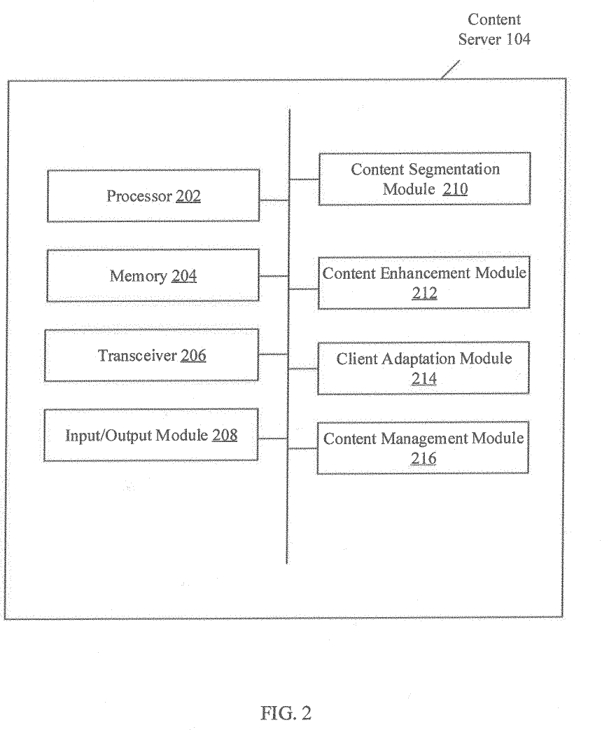

The content server 104 may be configured to store one or more content segments of the shared content in a segment database (not shown in fig). The content server 104 may be configured to retrieve from the segment database a content segment based on the content control request. In an embodiment, the content server 104 may be configured to display entire shared content. The content server 104 may be configured to display the content segment. The content server 104 may be configured to process one or more segments based on the content control request made by the user. The content server 104 may be configured to display content segment based on the content control request made by the user. The content server 104 may be configured to transmit the requested segment to the client device 104. The operations of the content server 104 have been discussed later in conjunction with FIG. 2.

In an embodiment, the client device 106 may refer to a computing device used by a user who may be a viewer of the shared content. The client devices 106 may include of one or more processors and one or more memories. The one or more memories may include computer readable code that may be executable by the one or more processors to perform predetermined operations. In an embodiment, the client device 106 may present the user-interface to the user to provide a request for user control input over the shared content. Further, the client device 106 may be configured to receive information pertaining to the shared content as modified by the smart content server 104. Further, the client device 108 may be configured to display the modified shared content from the content server 104. Examples of the client device 106 may include, but are not limited to, a personal computer, a laptop, a personal digital assistant (PDA), a mobile device, a tablet, a phabiet or any other computing device.

In an embodiment, the communication network 108 may correspond to a communication medium through which the Presenter Device 102, the Content server 104, and the Client devices 106 may communicate with each other. Such a communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802,16, 2G, 3G, 4G cellular communication protocols, and/or Bluetooth (BT) communication protocols. The communication network 108 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

FIG. 2 is a block diagram that illustrates a content server 104 configured to provide interactive control of shared content over a video conference to a user in accordance with some embodiments of the present disclosure. The content server 104 further comprises a processor 202, a memory 204, a transceiver 206, an input/output module 208, a content segmentation module 210, a content enhancement module 212, a client adaptation module 214 and content management module 216. The processor 202 may be communicatively coupled to the memory 204, the transceiver 206, the input/output module 208, the content segmentation module 210, the content enhancement module 212, the client adaptation module 214 and the content management module 216.

The processor 202 comprises suitable logic, circuitry, interfaces, and/or code that may be configured to execute a set of instructions stored in the memory 204. The processor 202 may be implemented based on a number of processor technologies known in the art. Examples of the Processor 202 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 comprises suitable logic, circuitry, interfaces, and/or code that may be configured to store the set of instructions, which may be executed by the processor 202. In an embodiment, memory 204 may be configured to store one or more shared content received from the Presenter Device 102. In an embodiment, the memory 204 may be configured to store one or more programs, routines, or scripts that may be executed in coordination with the processor 202. The memory 204 may be implemented based on a Random Access Memory (RAM), a Read-only Memory (ROM), a Hard Disk Drive (HDD), a storage server, and/or a Secure Digital (SD) card.

The transceiver 206 comprises of suitable logic, circuitry, interfaces, and/or code that may be configured to retrieve a set of operations associated with the content management module 216, via the communication network 108. The transceiver 206 may be further configured to transmit information pertaining to the content segments. In an embodiment, the transceiver may be configured to receive a control content request from one or more client devices 106. In an embodiment, the transceiver 206 may be configured to transmit one or more content segments to the client devices 106. The transceiver 206 may implement one or more known technologies to support wired or wireless communication with the communication network 108. In an embodiment, the transceiver 206 may include, but is not limited to, an antenna, a radio frequency (RE) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer.

The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The Input/Output (I/O) unit 208 includes suitable logic, circuitry, interfaces, and/or code that may be configured to receive an input or transmit an output. The input/output unit 208 includes various input and output devices that are configured to communicate with the processor 202. Examples of the input devices include, but are not limited to, a keyboard, a mouse, a joystick, a touch screen, a microphone, and/or a docking station. Examples of the output devices include, but are not limited to, a display screen like Liquid Crystal Display (LCD) or Light Emitting Diode (LED) display.

The content segmentation module 210 comprises suitable logic, circuitry, interfaces, and/or code that may be configured to receive a content control request made by a user from the client device 106 also referred to as the client device. In an embodiment, the content segmentation module 210 may be configured to receive the shared content front the presenter's device 102. In an embodiment, the content segmentation module 210 may be able to retrieve the shared content from the memory 204. The content segmentation module 210 may be configured to segment the shared content into a matrix of rows and columns. The content segmentation module 210 may be configured to support multiple content segments based on the content control requests made by the users of the client devices 106. In an example, if there is only one segment initially which is [1,1] matrix of rows and columns, subsequently when the user zooms vertically, the content segmentation module 210 may segment into two rows resulting in [2,1] matrix of rows and columns. In an example, if the user zooms horizontally then the module segments into two columns resulting in [2,2] matrix of rows and columns. The content segmentation module 210 may support matrix of rows and columns such as but not limited to [2,2], [3,3], [4,4] matrix of rows and columns and various sizes in between as required. In an embodiment, the content segmentation module 210 may transfer one or more content segments to the content management module 216.

The content enhancement module 212 comprises suitable logic, circuitry, interfaces, and/or code that may be configured to enhance the content segments. The content enhancement module 212 may use methods so as to not degrade quality of the content segments. The content enhancement module 212 may request a high quality or high-resolution image to the presenter device. In an embodiment, the content enhancement module 212 may be configured to upscale the one or more content segments. In an embodiment, the content enhancement module 212 may be configured to perform interpolation on the one or more content segments. In an example, if the control is requested for the shared content segment having a [1,1] matrix of rows and columns, requiring a [2,2] matrix of rows and columns for zoom in, then the content enhancement module 212 may interpolate at least 2 times the height, width of the image if and the original image is not including higher resolution already. The content enhancement module 212 may then apply image smoothening to reduce noise in the content segments. In an embodiment, the content enhancement module 212 may be configured to transfer the one or more content segments to the content management module 216. In an embodiment, the content enhancement module 212 may be configured to transfer the one or more content segments to the client adaptation module 214.

The client adaptation module 214 comprises suitable logic, circuitry, interfaces, and/or code that may be configured to adapt dynamically to the content control requests. The client adaptation module 214 may be configured to determine the type of content control request received. The content control request may be but not limited to zoom in, zoom out, scroll up, scroll down or scroll sideways a portion of the shared content. In an example, the user of client device 106-a may request to zoom in a particular portion of the shared content to have an enlarged view of the portion of the shared content. In an example, the user of the user of client device 106-a may also request to scroll up to a previous view of the shared content at the client device 106-a. In an embodiment, the client adaptation module 214 may be configured to determine the availability of the one or more content segments based on the content control requested by the user of the client device 106. In an embodiment, the client adaptation module 214 may be configured to select one or more pre-existing content segments based on the content control requested by the user of the client device 106. In an example the user of client device 106-c may request to zoom in the same portion of the shared content that was requested by the user of client device 106-a. In such a case, the client adaptation module 214 selects the existing content segment from the segment database and provides to the client device 106-c. In an embodiment, the client adaptation module 214 may be configured to decide the requirement of the processing operations by either one of or both the content segmentation module 210 or the content enhancement module 212 on the shared content.

In an example, the user of client device 106-c may request a larger zoom in of say 100 percent of the same content segment that was request by user of the client device 106-a which for example, was zoomed at 85 percent. The client adaptation module 214 may in such case decide to enhance the content segment further at the content enhancement module 212 and not segment at the content segmentation module 210. Some examples of factors on which the decision to adapt content by client adaptation module 214 is based are, if the content is already available for another client that can be re-used or if requests for content control require content segments and corresponding enhancements. In an embodiment, the client adaptation module 214 may be configured to determine the one or more content segments for reuse.

The content management module 216 comprises suitable logic, circuitry, interfaces, and/or code that may be configured to send and receive requests from the presenter device 102 and the client device 106. In an embodiment, the content management module 214 may be configured to receive the shared content from the presenter device 102. In an embodiment, the content management module 216 may be configured to serve the shared content to one or more client device 106. In an embodiment, the content management module 216 may be configured to accept content control request from the client device 106. The content management module 216 may be configured to respond to the received content control request. In an embodiment, the content management module 216 may be configured to receive one or more content segments from the client adaptation module 216. The content management module 216 may be configured to send the one or more selected content segments to the requesting client device 106.

In operation, the content server 104 may be configured to be initialized by one or more parameters of content server 104. In an embodiment, the client adaptation module 214 may identify a plurality of users participating in the video conference. The plurality of users refer to the clients associated with corresponding client devices or client devices 106. In an embodiment, the client adaptation module 214 may determine one or more attributes associated with the corresponding client devices. In an embodiment, the content management module 216 may receive the shared content from the presenter device 102. In an embodiment the content management module 216 may receive a content control request for the shared content, from the user of a client device 106.

In an embodiment, the client adaptation module 214 may be configured to determine the presence of the one or more content segments of the shared content in a segment database on on receiving the content control request. In an embodiment, the client adaptation module 214 may transfer operation to the content management module 216 when there is no content control request. In an embodiment, the client adaptation module 214 may retrieve the one or more content segments of the one or more content segments of the shared content from the segment database. In an embodiment, the content segmentation module 210 may segment the shared content into one or more content segments on receiving the content control request. In an embodiment, the content segmentation module 210 may segment the shared content into the one or more content segments in a row-column grid layout. The one or more content segments may be stored in a segment database.

In an embodiment, the content server 104 may modify the presentation of the one or more content segments based on the content control request. In an embodiment, the content enhancement module 212 may modify the one or more content segments of the shared content by enhancing the one or more content segments. In an embodiment, modifying the presentation of the one or more content segments may include scaling the one or more content segments of the shared content. The scaling of content segments may include zooming in and zooming out. In an embodiment, modifying the presentation of the one or more content segments may include scrolling over the one or snore content segments of the shared content.

In an embodiment, the content management module 216 may present the one or more content segments to the user on the client device 106. In an embodiment, the client adaptation module 214 may detect one or more pending content control requests from the client devices 106. In an example, a plurality of client devices 106 may make various control requests to the content.

In an embodiment, the content server 104 may initialize the one or more parameters of the content server for a first content presenter. In an embodiment, the content server 104 may re-initialize the one or more parameters of the content server for a second content presenter. In an embodiment, the first content presenter is a user of the presenting device presenting at a first time instance. In an embodiment, the second content presenter is a user of the presenting device presenting a different shared content. In an example, when the second presenter takes over the presenting device 102 and uploads a different shared content, the content server 104 subsequently re-initializes. In an example, there may be a request to the presenting device 102 for a presenter control from one of the client devices 106-d. In an embodiment, the client device 106-d may act as a presenting device 102 when the user of the presenting device 102 accepts the presenter control request from the client device 106-d. The content server 104 may re-initialize in such a scenario.

In an embodiment, the content management module 216 may be configured to store the one or more segmented contents in the segment database. In an embodiment, the segment database may be located in the memory 204. In an embodiment, the segment database may be located in the content management module 216. In an embodiment, content management module 216 may clear the segment database on re-initialization of the content server 104. In an example, if a shared content is being presented from the presenter device 102 for a new session of video conference the content server reinitialized and clears the segment database of the previous data. In an embodiment, the content management module 216 may be configured to transmit the shared content received from presenter device 102 to the one or more client devices 106. In an embodiment, content management module 216 may be configured to transmit the received content segment to the client device 106 that has requested the content control.

In an example, the user of a client device 106-b may request zooming of portion of content that is being presented by a user of the presenter device 102. The client adaptation module 214 of the content server 104 may look for availability of content segment based on the content control request, in the segment database. If the client adaptation module 214 finds the required content segment as requested, from the segment database, then the segment is transmitted to the client device 106-b. If the required content segment does not exist in the segment database, then the client adaptation module 214 transfers the processing to the content segmentation module 210. The content segmentation module 210 segments the shared content and transfers the segment to the content enhancement module 212. The content enhancement module 212 enhances the content segments. Subsequently, the content management module 216 receives the content segment and transmits the received content segment to the client, device 106-b.

In an embodiment, the input/output (I/O) unit 210 may be configured to display the shared content being presented on display screen of the content server 104. In an embodiment, the input/output (i/o) unit 210 may be configured to display one or more screens of the client device 106. In an embodiment, the I/O unit 210 may be configured to display one or more segmented content as provided to the client devices 106.

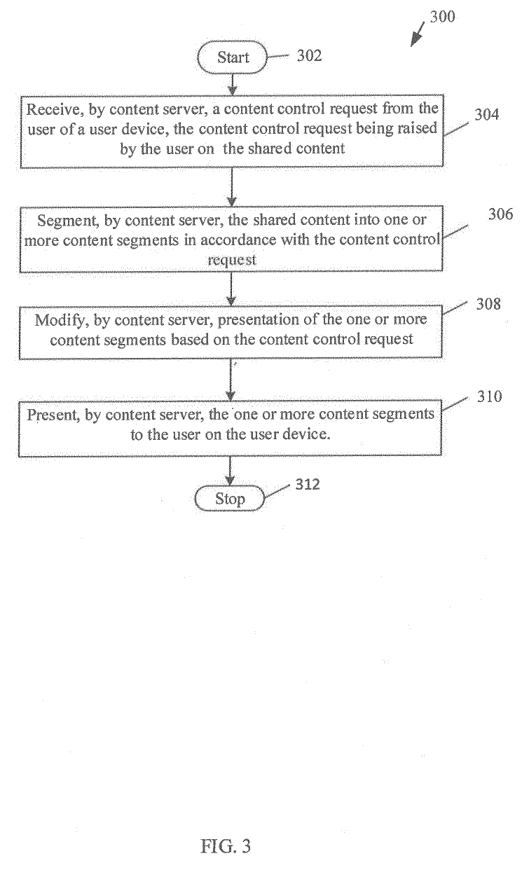

FIG. 3 is a flowchart illustrating a method 300 for providing interactive control of shared content over a video conference to a user, in accordance with some embodiments of the present disclosure. The method starts at step 302 and proceeds to step 304. At step 304, the content server 104 may receive a content control request from the user of a client device, the content control request being raised by the user on the shared content. In an embodiment, the content server 104 may determine the presence of the one or more content segments of the shared content in a segment database.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step 306, the method 300 includes segmenting, by the content server, the shared content into one or more content segments in accordance with the content control request. In an embodiment, the shared content is segmented into the one or more content segments in a row-column grid layout. In an embodiment, the one or more content segments of the shared content may be stored in a segment database.

At step 308, the method 300 includes modifying by the content server, the presentation of the one or more content segments based on the content control request. In an embodiment, modifying the presentation of the one or snore content segments comprises one of scaling, by the content server, the one or more content segments of the shared content; and scrolling, by the content server, over the one or more content segments of the shared content. In an embodiment, the one or more content segments of the shared content is scaled by one of zooming in and zooming out. In an embodiment, the one or more content segments of the shared content may be stored in a segment database. At step 310, the one or more content segments are presented to the user on the client device by the cement server.

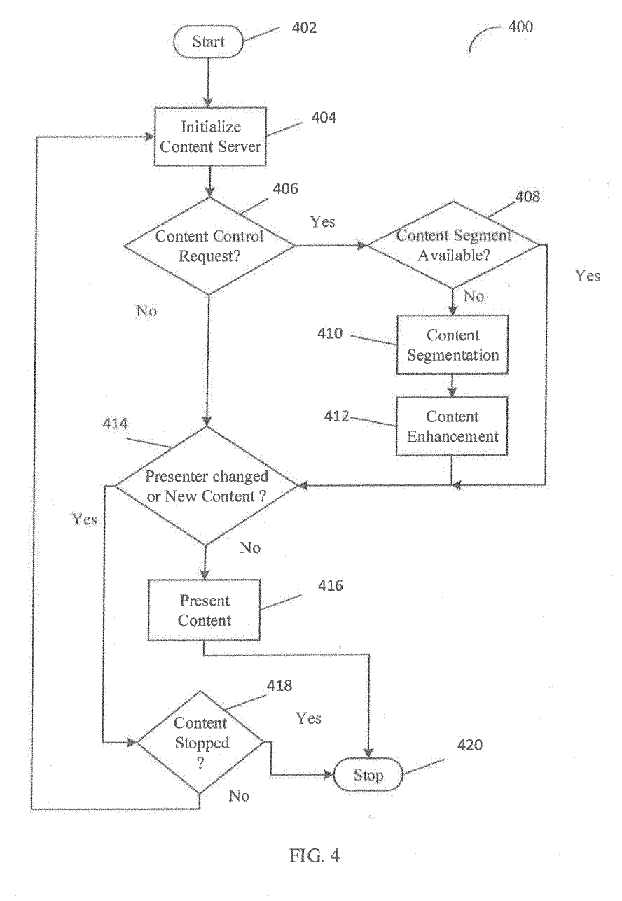

The operation of the content server 104 has been further explained with the help of FIG. 4 in conjunction with FIG. 2 and FIG 1. FIG. 4 is a flowchart illustrating a method 400 of providing interactive control of shared content over a video conference to a user, in accordance with some embodiments of the present disclosure. The method starts at step 402 and proceeds to step 404. At step 404, the method 400 includes initializing one or more parameters of the content server. In an embodiment, the content server 104 may be initialized for a video conference on the transmission of shared content from a first content presenter on the presenter device, for example the presenter device 102 of FIG. 1. In an embodiment, the content server 104 may be initialized when there is a change in the user of the presenter device 102 or a takeover of the presenter device 102 from first content presenter by a second content presenter. In an example, a user of the client device 106-b may request floor control or the role of the second content presenter. In an embodiment, the first content presenter may accept the request. In an embodiment, the content server 104 may be initialized for a video conference by a request for transmission of shared content to the content server 104 from the presenter device 102.

At step 406, the method 400 includes continuous checking for pending content control requests. In an embodiment, the client adaptation module 214 may continuously check for the pending content control requests. If there are no content requests then the execution moves directly to step 414. If there are pending content control requests then the execution moves to step 408. At step 408, the method 400 includes checking for the availability of the content segment based on the content control request. In an embodiment, the client adaptation module 214 may check for the availability of one or more content segments based on the content control request. At step 408, if content segments are available as per the content control request, then the execution moves to step 414. In an embodiment, the client adaptation module 214 may be configured to transmit the available content segment to the client device 106 requesting the content control.

At step 410, the method 400 includes segmenting the shared content when no content segments are available, based on the client control request. In an embodiment, the client adaptation module 214 may transfer the processing to the content segmentation module 210 when no segments are available. In an embodiment, the content segmentation module 210 may segment the shared content on receiving instructions from the client adaptation module 214. The content segmentation module 210 may segment the shared content into a matrix of rows and columns. After step 410, the execution moves at step 412. In an embodiment, the content segmentation module 210 may transfer one or more segmented content to the content enhancement module 212 for interpolation of the segments.

At step 412, the method 400, includes enhancement of the content segments. In an embodiment, the content enhancement module 212 may perform processing on the content segments for the enhancement of the quality of the content segments. In an embodiment, the content enhancement module 212 may be configured to request for specific content segments to the client adaptation module.

At step 414, the method 400 includes checking whether the presenter of the shared content or the shared content has changed. If any of the presenter of the shared content or the shared content has changed then the execution moves to step 418. If there is no change in any of the presenter of the shared content or the shared content then the shared content or the content segment is presented to the user of the client device at step 416. In an example, the shared content may be presented to the user of the client devices 106 when there is no content control request. In an example, if a content control request has been received from the client device 106-b then the content segment based on the content control request may be presented to the client device 106-b at step 416. At step 418, the method 400 may include querying to the user of the presenting device for stopping the presentation of the shared content. If ‘Yes’ then the presentation of the shared content is stopped at step 420. If ‘No’ then the content server is reinitialized and the execution starts again from step 404.

The present disclosure enables the presenter to have control for proper viewing of the content being presented. Manual process of making back-to-back requests to the user of the presenting device to move up or down, zoom in or out and the like have been overcome by this disclosure. In an embodiment, the content server 104, in accordance with the present invention takes into account the enhancement of the original content by methods such as up-sampling so that the segmentation may not result in loss of quality. In an embodiment, the content adaptation is dynamic as per request of the client devices 106. In an embodiment, the content adaptation is done specifically tor the requested client without any pre-defined configurations. Such and other advantages, would he apparent to a person skilled in the art.

A person having ordinary skill in the art will appreciate that the scope of the disclosure is not limited to the one or more common features that have been described herein.

### Computer System

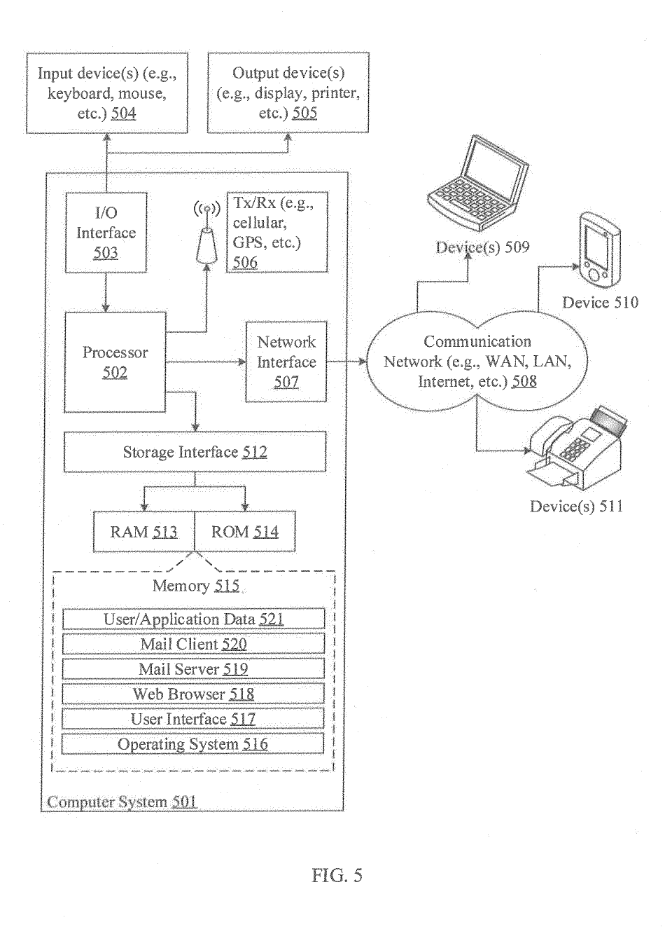

FIG. 5 illustrates a block diagram of an exemplary computer system for implementing embodiments consistent with the present disclosure. Variations of computer system 501 may be used for providing interactive control of shared content over a video conference to a user. The computer system 501 may comprise a central processing unit (“CPU” or “processor”) 502. Processor 502 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 510, 511, and 512. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft.NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-only Memory (ROM), volatile memory, nonvolatile memory, hard drives, Compact Disc (CD) ROMs, Digital Video Disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

I/we claim:

1. A method of providing interactive control of shared content over a video conference to a user, the method comprising:
receiving, by a content server, a content control request from the user of a client device, the content control request being raised by the user on the shared content;
segmenting, by the content server, the shared content into one or more content segments based on the content control request;
modifying, by the content server, presentation of the one or more content segments based on the content control request; and
presenting, by the content server, the one or more content segments to the user on the client device.

2. The method as claimed in claim 1 and further comprising:
initializing, by the content server, one or more parameters of the content server;
identifying, by the content server, a plurality of users participating in the video conference, the plurality of users associated with corresponding client devices;
determining, by the content server, one or more attributes associated with the corresponding client devices; and
receiving, by the content server, the shared content, wherein the shared content is presented to the corresponding client devices by a first content presenter.

3. The method as claimed in claim 1, wherein the shared content is segmented into the one or more content segments in a row-column grid layout.

4. The method as claimed in claim 1, wherein the one or more content segments are stored in a segment database.

5. The method as claimed in claim 1, wherein receiving the content control request comprises:
determining, by the content server, presence of the one or more content segments of the shared content in a segment database; and
retrieving, by the content server, the one or more content segments of the one or more content segments of the shared content from the segment database.

6. The method as claimed in claim 1 further comprising:
enhancing, by the content server, the one or more content segments of the shared content.

7. The method as claimed in claim 1, wherein modifying the presentation of the one or more content segments comprises one of:
scaling, by the content server, the one or more content segments of the shared content wherein scaling is by one of zooming in and zooming out; and
scrolling, by the content server, over the one or more content segments of the shared content.

8. The method as claimed in claim 2 and further comprising:
detecting, by the content serves; one or more pending content control requests from the corresponding client devices.

9. The method as claimed in claim 2 and further comprising:
re-initializing, by the content server, the one or more parameters of the content server for a second content presenter.

10. A content server for providing interactive control of shared content over a video conference to a user, the content server comprising:
a processor; and
a memory, communicatively coupled to the processor, wherein the memory stores processor-executable instructions, which, on execution, causes the processor to:
receive a content control request from a user of a client device, the content control request being raised by the user on the shared content;
segment the shared content into one or mom content segments based on the content control request;
modify presentation of the one or more content segments based on the content control request; and
present the one or more content segments to the user on the client device.

11. The content server as claimed in claim 11, wherein the processor is further configured to:
initialize one or more parameters of the content server;
identity a plurality of users participating in the video conference, the plurality of users associated with corresponding client devices;
determine one or more attributes associated with the corresponding client devices; and
receive the shared content, wherein the shared content is presented to the corresponding client devices by a first content presenter.

12. The content server as claimed in claim 11, wherein the processor is configured to the shared content is segmented into the one or more content segments in a row-column grid layout.

13. The content server as claimed in claim 11, wherein the one or more content segments are stored in a segment database in the content servers.

14. The content server as claimed in claim 11, wherein to receive the content control request the processor is configured to:
determine the presence of the one or more content segments of the shared content in a segment database; and
retrieve the one or more content segments of the one or more content segments of the shared content from the segment database.

15. The content server as claimed in claim 11, wherein, processor is further configured to enhance the one or more content segments of the shared content.

16. The content server as claimed in claim 11, wherein to modify the presentation of the one or more content segments the processor is configured to:
scale the one or more content segments of the shared content wherein scaling comprises one of zooming in and zooming out.

17. The content server as claimed in claim 11, wherein, to modify the presentation of the one or more content segments the processor is configured to:
scroll over the one or more content segments of the shared content.

18. The content server as claimed in claim 11, wherein the processor is further configured to detect one or more pending content control requests from the corresponding client devices.

19. The method as claimed in claim 11 wherein the processor is farther configured to re-initialize the one or more parameters of the content server for a second content presenter.

20. A non-transitory computer-readable storage medium having stored thereon, a set of computer-executable instructions for causing a computer comprising one or more processors to perform steps comprising:
receiving a content control request from the user of a client device, the content control request being raised by the user on the shared content;
segmenting the shared content into one or more content segments based on the content control request;
modifying presentation of the one or more content segments based on the content control request; and
presenting the one or more content segments to the user on the client device.
